(19) United States
(12) Patent Application Publication
(10) Pub. No.: US 2012/0052975 A1
(43) Pub. Date: Mar. 1, 2012

(54) Mr. "V" Right or Left Handed Putter Negative Loft

(76) Inventor: Richard Thomas Vlosich, Prescott Valley, AZ (US)

(21) Appl. No.: 13/102,004

(22) Filed: May 5, 2011

Related U.S. Application Data
(60) Provisional application No. 61/395,021, filed on May 7, 2010.

(51) Int. Cl. A63B 53/04; A63B 53/02; B23B 35/00; A63B 53/00

(52) U.S. Cl. 473/251; 473/340; 408/1 R; 473/325

(57) ABSTRACT

The front and back striking surfaces are identical mirror images of each other. If the front surface for (right handed putter) is −2 degrees negative loft the back surface is −2 degrees negative loft.

If the front surface for a left handed putter has a −4 degrees negative loft the back surface of the putter has −4 degrees negative loft.

Looking at the heel from the back lengthwise you would see a “V” shaped head. The center of gravity is above the center of height of the putter resulting in forward force striking above the equator or center of the golf bal due to the negative loft of the putter face resulting in immediate roll of the golf ball.

The center of gravity can be raised by drilling holes lengthwise along the putter head and leaving the holes empty or adding weight.

### BRIEF DESCRIPTION OF DRAWINGS

FIG. 1A Shows various aspects of the finished negative angle loft putter head

FIG. 1B View from heel of putter shows the through hole and negative loft of striking surfaces

FIG. 1C Shows view of ball striking surfaces and putter shaft

### DRAWING

### Reference Numerals

10 Putter shaft hole
11 Toe negative angle loft surface
12 Negative angle loft ball striking surface
13 Ball aiming symbol
14 Heel negative angle loft surface
15 Longitudinal through hole
16 Negative angle loft of four vertical surfaces
17 Putter shaft

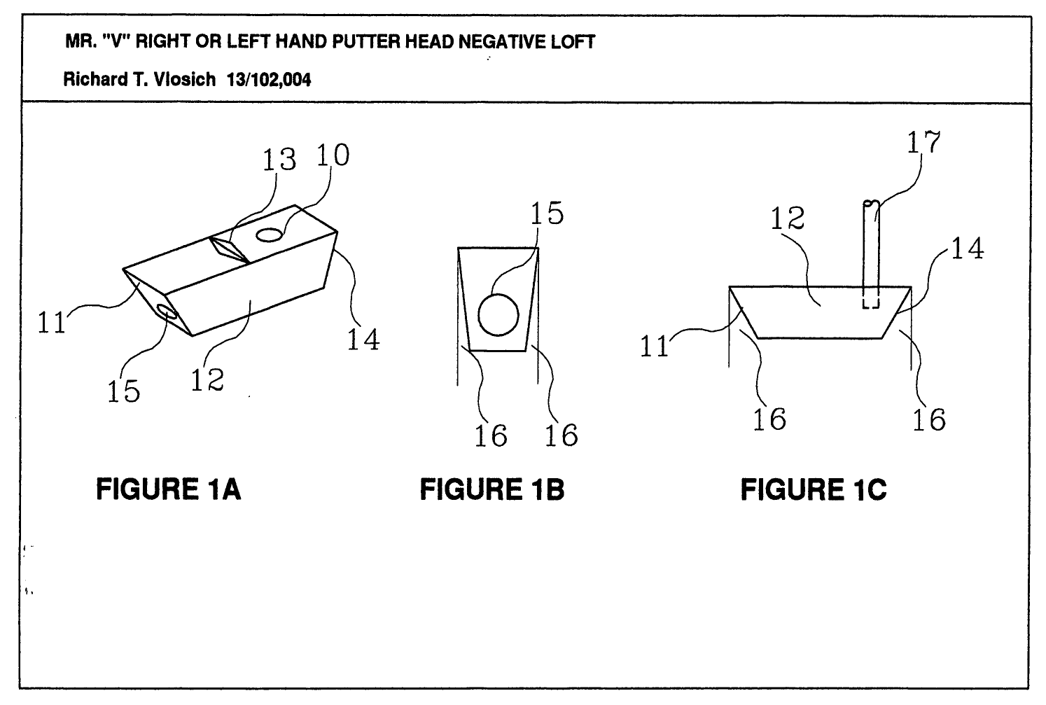

### Detailed Description FIGS. 1A, 1B, and 1C First Embodiment

One embodiment of the putter head negative loft is illustrated in FIG. 1A (top view) and FIG. 1C (right side view).

The putter head has a metal aluminum or wooden body.

A longitudinal through hole 15 is drilled and left hollow or weight added into the space to lower or raise the center of gravity.

The negative loft surfaces 11, 12, 14, 16 are cut into the surfaces to predetermined negative loft angles.

The shaft hole 17 and aiming symbol 13 are added.

### Operation—FIGS. 1A, 1B, 1C

The putter can be used either right handed or left handed. Left handed surface is a mirror image of the right handed surface.

### Advantages

The putter head strikes the golf ball above the center-equator whereby top spin rolls the ball more accurately, longer and without lofting. The higher center of gravity of the putter contributes to more top spin and force.

Accordingly the reader will see that the negative loft putter will create immediate top roll, no lifting of the ball and will roll farther and more accurately than the positive lofted golf putters used today. The putter's used today loft the ball at impact.

The putter can be used to putt right handed or left handed because of the same negative loft on both striking surfaces.

### Drawings

The attached sheet (sheet 1) of drawings includes changes to FIG. 1 and replaces the original sheet. In FIG. 1 previously omitted reference numbers have been added. The attached sheet drawing includes corrections to FIG. 1 and replaces original sheet. The attached red-marked sheet indicates in red the corrections made to FIG. 1.

1-6. (canceled)

10. A negative angle lofted golf putter head having negative angle loft on the front, back, heel, and toe vertical surfaces of the putter head.

11. The putter head of claim 10 wherein said body of material is composed of metals, aluminum or wood.

12. The putter head of claim 10 wherein said body is elongated having six surfaces: two height, two width and two end surfaces.

13. The putter head of claim 10 wherein said body is elongated and has a longitudinal hole drilled into the body from heel to toe extending the full length inside the body.

14. The method of claim 13 wherein said hole is drilled, hole can be left hollow or filled with weight whereby the center of gravity of putter head in claim 10 is raised or lowered.

15. The putter head of claim 10 wherein has the heel and toe end surfaces cut with equal negative angle of loft.

16. The putter head of claim 10 wherein has the right and left striking surfaces cut with equal negative angle loft.

17. The putter head of claim 10 wherein has an aiming symbol and putter shaft hole.

18. The putter head of claim 10 wherein with the putter shaft can be used for right or left handed putting.

19. The putter head of claim 10 wherein will impact a golf ball above the equator whereby causing immediate top spin forward roll without lifting the golf ball.

20. The putter head of claim 10 wherein has a center of gravity higher than the center of a golf ball whereby causing the great force to roll the ball farther and more top roll.

21. The putter head of claim 10 wherein the striking surfaces form a “V” shape.

22. The putter head of claim 10 wherein the heel and toe is cut at negative angles whereby varying the weight and center of gravity.
